(19) United States
(12) Patent Application Publication
(10) Pub. No.: US 2026/0208808 A1
(43) Pub. Date: Jul. 23, 2026

(54) MOTORCYCLE IGNITION COVER

(71) Applicant: Rayan Cuzmar, Albuquerque, NM (US)

(72) Inventor: Rayan Cuzmar, Albuquerque, NM (US)

(21) Appl. No.: 19/034,540

(22) Filed: Jan. 22, 2025

(51) Int. Cl. B62J 23/00

(52) U.S. Cl. CPC B62J 23/00

(57) ABSTRACT

An ignition cover can include a top circular portion located above and coupled to a plug portion that extends angularly from the top circular portion, with the plug portion having a bottom circular portion with a radius smaller than that of the top circular portion, wherein the plug portion fits within a cavity of an ignition (e.g., a motorcycle ignition) with the top circular portion disposed on the ignition cover and adapted to protect the ignition, wherein the top circular portion has a width that is smaller than that of the plug portion. A semi-circular section can extend from the top circular portion to provide a handle to grab and manipulate the ignition cover. The ignition cover functions as a plug to protect the ignition.

### TECHNICAL FIELD

Embodiments are related to the field of ignitions. Embodiments further relate to motorcycle ignitions. Embodiments also relate to devices for protecting an ignition.

### BACKGROUND

Motorcycle ignitions are critical components for starting and operating motorcycles, yet they are often exposed to harsh environmental conditions. Unlike automobile ignitions, which are typically housed within enclosed compartments, motorcycle ignitions are exposed to external elements such as rain, snow, dust, and debris. This exposure creates significant challenges in maintaining the integrity and functionality of the ignition system.

Moisture, water, and debris entering the ignition can lead to corrosion, electrical malfunctions, and mechanical damage, rendering the motorcycle inoperable. For instance, water ingress can short-circuit electrical connections, while debris may obstruct the mechanical operation of the ignition cylinder. These issues compromise reliability, increase maintenance costs, and can shorten the lifespan of the motorcycle's ignition system.

A need exists for a new approach to protecting motorcycle ignitions from environmental factors. A robust solution must provide reliable sealing, withstand long-term exposure to moisture and debris, and maintain functionality in adverse conditions. Furthermore, it should be cost-effective, easy to implement, and compatible with a wide range of motorcycle models to ensure broad adoption.

The disclosed embodiments address these unmet needs by providing an improved apparatus for protecting motorcycle ignitions from environmental damage, ensuring durability, reliability, and enhanced performance under various conditions.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for an apparatus for protecting an ignition.

It is another aspect of the embodiments to provide for an ignition cover.

It is a further aspect of the embodiments to provide for an ignition cover that functions as a plug that protects an ignition.

The aforementioned aspects and other objectives and advantages can now be achieved as described herein.

In an embodiment, an ignition cover can include a top circular portion located above and coupled to a plug portion that extends angularly from the top circular portion, with the plug portion having a bottom circular portion with a radius smaller than that of the top circular portion, wherein the plug portion fits within a cavity of an ignition with the top circular portion disposed on the ignition cover and adapted to protect the ignition, wherein the top circular portion has a width that is smaller than that of the plug portion. The ignition cover can further include a semi-circular section that extends from the top circular portion to provide a handle to grab and manipulate the ignition cover, wherein the ignition cover functions as a plug to protect the ignition.

In an embodiment, the ignition cover including the top circular portion, the plug portion, and the semi-circular portion can comprise a rubber material.

In an embodiment, a key ring/clip can be connected to the semi-circular section that extends from the top circular portion.

In an embodiment, the plug portion can include a group of plug sections wherein grooves respectively separate each plug section from one another.

In an embodiment, the group of plug sections can comprise four plug sections.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a bottom view of an ignition cover, which can be implemented in accordance with an embodiment;

FIG. 2 illustrates a side view of an ignition cover, in accordance with an embodiment;

FIG. 3 illustrates a top view of an ignition cover with a key ring/clip attached thereto, in accordance with an embodiment; and

FIG. 4 illustrates a top view of an ignition cover plugged into an ignition, in accordance with an embodiment.

It is important to note that while the drawings and figures presented herein are illustrated in black and white, they might have originally been created and displayed in color. As a result, those skilled in the art will understand that even though the images and figures may not display color, they may actually depict features in color.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets.”

The term “motorcycle ignition” as utilized herein can relate to the system, apparatus or mechanism within a motorcycle that initiates the combustion process in the engine to start and operate the vehicle. This system typically includes components such as the ignition switch, spark plug(s), ignition coil, and associated circuitry. The ignition system is responsible for generating and delivering the electrical spark required to ignite the air-fuel mixture in the engine's combustion chamber, enabling the engine to run.

Ignition, in a broader context, can relate to the process or mechanism of initiating combustion in an engine or other system that relies on the controlled burning of fuel for energy production. It encompasses systems used in various vehicles, machinery, and equipment, such as cars, motorcycles, boats, and industrial engines. An ignition system typically includes components that generate and deliver the necessary spark or heat to ignite a fuel-air mixture, and it may also refer to systems designed to activate the flow of power or enable the operation of an engine or device. Ignition systems can be mechanical, electrical, or electronic in nature, depending on the application.

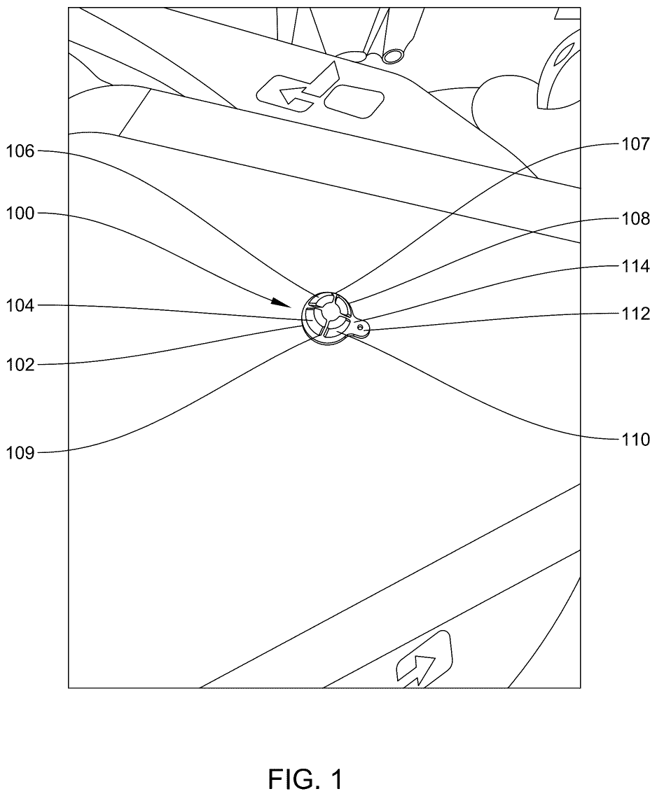

FIG. 1 illustrates a bottom view of an ignition cover 100, which can be implemented in accordance with an embodiment. The ignition cover 100 includes a top circular portion 102 that is located above and coupled to a plug portion 103 (indicated by the dashed circle 107 in FIG. 1) that extends angular downward from the top circular portion 102. The plug portion 103 can be configured to include a group of plug sections 104, 106, 108, 110, wherein grooves respectively separate each of the plug sections 104, 106, 108, 110 from one another. An example of a groove is the groove 109 shown in FIG. 1. In the embodiment shown in FIG. 1, four grooves are shown respectively between the plug sections 104, 106, 108, 110. The plug portion 103 also includes a bottom circular portion (separated by the grooves) with a radius smaller than that of the top circular portion 103.

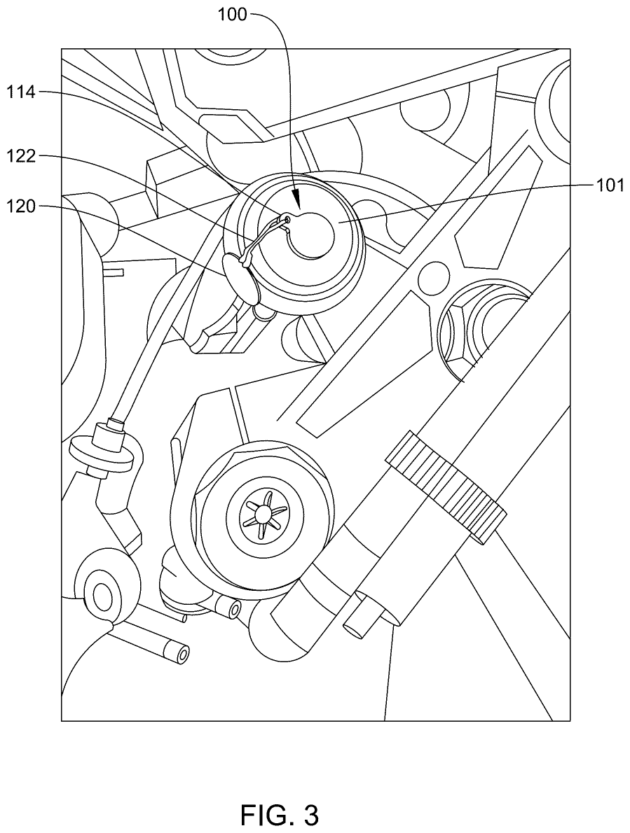

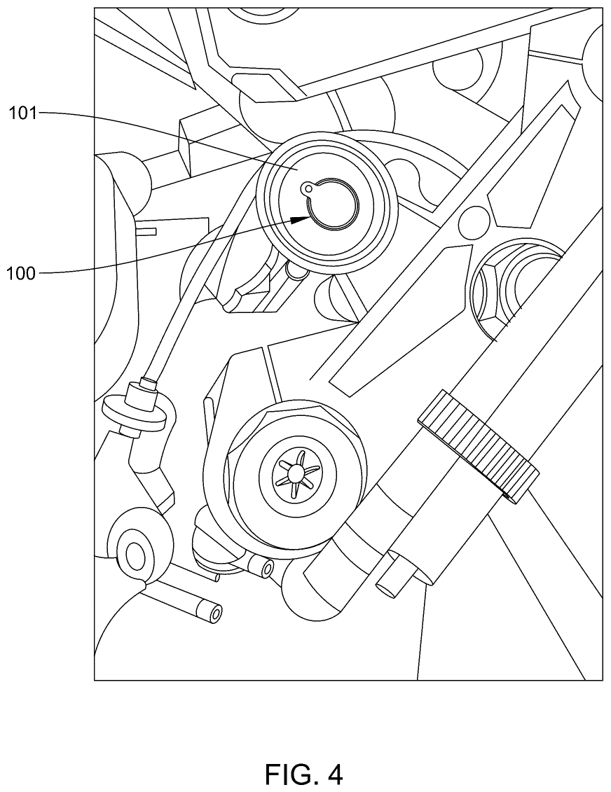

The plug portion 103 can fit within a cavity of an ignition (e.g., see ignition 101 depicted in FIG. 3 and FIG. 4) with the top circular portion 102 disposed on the ignition with the ignition cover 100 adapted to protect the ignition. The top circular portion 102 has a width that is smaller than that of the plug portion 103. A semi-circular section can extend from the top circular portion 102 to form a handle 114 to grab and manipulate the ignition cover 100, which functions as a plug to protect the ignition. The handle 114 can be configured to include a hole 112 through which a chain, string, wire, or other device may be inserted.

The ignition cover 100 may be formed from a rubberized material (e.g. rubber) The entire ignition cover 100 may be formed from the same rubberized material. That is, the top circular portion 102, the plug portion 103, and the semi-circular portion can each be formed from the same rubberized material. In some embodiments, each component may be formed from different types of material, some rubberized and some formed of other materials such as plastic. In a preferred embodiment, however, the entire ignition cover 100 may be formed from the same material and molded into its shape and functionality.

Note that materials other than rubber or a rubberized material may be implemented in the context of alternative embodiments. For example, in alternative embodiments, alternative materials may be used instead of rubber or a rubberized material depending on the desired properties such as durability, temperature resistance, flexibility, and environmental exposure.

One example of a material that may be utilized in place of rubber or a rubberized material is silicone. Silicone can withstand extreme temperatures without losing its elasticity or integrity, making it suitable for ignition covers exposed to engine heat. Silicone also can retain flexibility over a wide range of temperatures, ensuring a secure fit in the ignition cavity. In addition, silicone is highly resistant to UV light, ozone, and weathering, which is ideal for outdoor applications. Furthermore, silicone is resistant to oils, fuels, and other automotive fluids.

Another material that may be utilized in place of the rubber or rubberized material is a thermoplastic elastomer (TPE), which can be engineered to achieve specific hardness and elasticity, providing a balance between rigidity and flexibility. TPE is often lighter than rubber, which can reduce the overall weight of the ignition cover. TPE is also generally less expensive than silicone and is easier to manufacture in complex shapes. TPE is also recyclable, making it a more environmentally friendly option.

A further example of a material that may be utilized instead of the aforementioned rubber or rubberized material is ethylene propylene diene monomer (EPDM). EPDM performs well in outdoor environments, resisting degradation from sunlight and weather. EPDM also has excellent elasticity and can maintain its shape and sealing properties over time. In addition, EPDM is resistant to automotive chemicals, such as brake fluids and coolant.

Another example of a material that can be utilized instead of the aforementioned rubber or rubberized material is polyurethane, which is extremely wear-resistant and has a high tear strength, making it suitable for long-term use. It also can endure mechanical wear and tear, ensuring a longer lifespan, and furthermore, offers good flexibility and sealing properties, while also being more rigid than traditional rubber if required.

An additional example of a material that can be used instead of rubber or rubberized material is neoprene, which is well-suited for environments where the cover may come into contact with automotive oils and fuels. Neoprene maintains flexibility and durability over a broad temperature range. Neoprene also resists moisture and environmental degradation, providing effective protection in humid or wet conditions.

Fluoroelastomers are also examples of materials that can be utilized in place of the aforementioned rubber or rubberized material. Fluoroelastomers (e.g., Viton) can resist aggressive fuels, oils, and solvents. Fluoroelastomers can also withstand higher temperatures compared to standard rubber materials. In addition, Fluoroelastomers are robust and can resist cracking or hardening over time.

The grooves between the plug sections 104, 106, 108, 110 can provide flexibility to the plug portion 103, allowing it to compress slightly when inserted into the ignition cavity. This flexibility ensures a snug and secure fit within the ignition cavity, thereby enhancing the effectiveness of the ignition cover 100 in preventing the ingress of moisture, dust, and debris. The grooves also can facilitate easy removal and re-insertion of the ignition cover 100 by reducing friction between the plug portion 103 and the cavity walls during operation.

The top circular portion 102 can serve as a protective barrier against environmental exposure. When the ignition cover 100 is installed, the top circular portion 102 rests above the ignition cavity, preventing direct contact with water, dirt, or other contaminants. The semi-circular handle 114 provides a user-friendly feature that enables quick and efficient removal of the cover when access to the ignition is needed.

The hole 112 in the handle 114 allows for convenient attachment of a tether, chain, or string, ensuring that the ignition cover 100 can be securely fastened to the motorcycle or kept within easy reach when removed. This feature reduces the likelihood of losing the ignition cover 100 during maintenance or while the motorcycle is in use.

The material selection for the ignition cover 100 plays a critical role in its performance and durability. In a preferred embodiment, the rubberized material used can be both weather-resistant and durable, capable of withstanding prolonged exposure to ultraviolet (UV) rays, temperature fluctuations, and mechanical wear. Alternative embodiments may incorporate different materials, such as plastics or composite materials, to provide specific benefits such as enhanced rigidity or resistance to certain chemicals. The use of a single material throughout the ignition cover 100 can simplify the manufacturing process and ensures consistent performance across all its components.

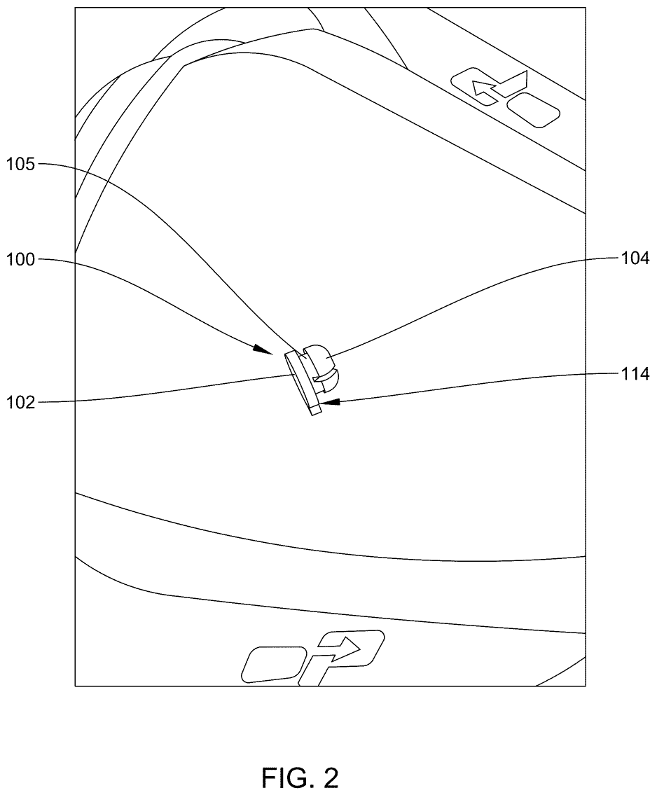

FIG. 2 illustrates a side view of the ignition cover 100 shown in FIG. 1, in accordance with an embodiment. In the configuration depicted in FIG. 2, the top circular portion 102 is shown next to an indented section 105 of the plug section 104 of the plug portion 103. That is, the plug portion 103 includes the intended section 105 which runs radially about the plug portion 103 between the top circular portion 102 and the plug portion 103. The handle 114 is also shown in FIG. 2 as extending outward from the ignition cover 100.

The indented section 105 of the plug portion 103, as shown in FIG. 2, further enhances the functionality of the ignition cover 100 by serving as a transitional region between the top circular portion 102 and the plug portion 103. This indentation allows for greater flexibility and adaptability when the ignition cover 100 is inserted into the ignition cavity. The indented section 105 also contributes to a more effective seal by enabling the plug portion 103 to conform tightly to the inner walls of the ignition cavity, reducing the risk of water or debris infiltration.

FIG. 3 illustrates a top view of the ignition cover 100 with a key ring/clip 120 attached thereto, in accordance with an embodiment. As shown in FIG. 3, the ignition cover 100 with its plug portion 103 is fitted snuggly within a cavity of the ignition 101. It should be appreciated that the cavity cannot be seen in detail because the plug portion 103 of the ignition cover 100 is fitted within the cavity. In the configuration shown in FIG. 3, a string 122 extends from the hole formed in the handle 114 to the key ring/clip 120.

The inclusion of the key ring/clip 120 in FIG. 3 highlights the versatility of the ignition cover 100. This optional feature provides users with an integrated storage solution for keys or other small accessories. By attaching a string 122 or chain to the handle 114 via the hole, users can ensure that the ignition cover 100 and the associated key(s) are always within reach, minimizing the chance of misplacement. The string 122 also allows for convenient removal of the ignition cover 100 by pulling gently on the attached string, simplifying the operation for the user.

FIG. 4 illustrates a top view of an ignition cover 100 plugged into the ignition 101, in accordance with an embodiment. In the embodiment shown in FIG. 4, the key ring/clip 120 shown in FIG. 4 is not included in this particular embodiment. That is, the key ring/clip 120 is an optional feature that can be implemented in the context of some embodiments, but not in others.

The ignition cover 100 functions as a plug that can be inserted into the ignition 101 to protect it. The ignition cover 100 can be implemented as a low profile design which can also function as a key holder as the key ring/clip 120 can be attached while still remaining in the ignition 101. The ignition cover 100 is not only durable, but also convenient and weatherproof, providing protection to the ignition 101.

The ignition cover 100 provides an additional level of protection for the ignition 101 from climates that may be harmful to the ignition component of a motorcycle. The ignition cover 100 is multifunctional, meaning that it can have the key ring/clip 101 attached so that a key(s) can stay with the motorcycle.

Advantages associated with the ignition cover 100 include its reliability, practicality, and functionality. The ignition cover 100 can act as a barrier against all types of weather, which may be harmful to the ignition system. The ignition system is an essential component of any motorcycle and with it being exposed, it is susceptible to harsh elements such as snow, rain, dirt, etc. which can damage the internal components of the ignition and lead to a costly repair or replacement. The convenience of the ignition cover 100 offers a significant form of protection and peace of mind to the consumer while also being inexpensive.

The low-profile design of the ignition cover 100, as illustrated in FIG. 3 and 4, is particularly advantageous for maintaining the aesthetic appeal and aerodynamic performance of the motorcycle. Unlike bulkier protective covers, the ignition cover 100 integrates seamlessly with the motorcycle's design, ensuring that it does not interfere with the rider's experience or the motorcycle's performance.

The multifunctionality of the ignition cover 100 extends beyond protection and key storage. In some embodiments, the ignition cover 100 can be color-matched or customized with logos, patterns, or other designs to complement the motorcycle's branding or the rider's preferences. This feature adds a personal touch while maintaining the core protective functionality.

Another significant advantage of the ignition cover 100 lies in its ease of use. The semi-circular handle 114 provides an ergonomic grip, allowing users to remove and replace the cover quickly and without the need for tools. This simplicity ensures that the ignition cover 100 can be used effectively by riders of all skill levels, from beginners to experienced motorcyclists.

In addition to its weatherproof properties, the ignition cover 100's materials can be selected to resist other environmental factors, such as ultraviolet (UV) radiation, salt spray, and chemical exposure. These features make the ignition cover 100 an ideal solution for riders in coastal areas, regions with extreme weather conditions, or environments where chemical exposure is a concern.

By addressing the shortcomings of existing solutions, the ignition cover 100 provides a cost-effective and innovative approach to protecting motorcycle ignitions. Its durability, versatility, and user-friendly design make it an essential accessory for any motorcycle owner, ensuring long-term protection and convenience while reducing maintenance costs.

Based on the foregoing, it can be appreciated that a number of embodiments are disclosed herein including preferred and alternative embodiments. In an embodiment, an ignition cover can be configured to include: a top circular portion located above and coupled to a plug portion that extends angularly from the top circular portion, with the plug portion having a bottom circular portion with a radius smaller than that of the top circular portion, wherein the plug portion fits within a cavity of an ignition with the top circular portion disposed on the ignition cover and adapted to protect the ignition, wherein the top circular portion has a width that is smaller than that of the plug portion; and a semi-circular section that extends from the top circular portion to provide a handle to grab and manipulate the ignition cover, wherein the ignition cover functions as a plug to protect the ignition.

In an embodiment, the top circular portion, the plug portion, and the semi-circular portion can comprise a rubber material or another type of material such as discussed previously.

In an embodiment, a key ring/clip can be connected to the semi-circular section that extends from the top circular portion.

In an embodiment, a key ring can be connected to the semi-circular section that extends from the top circular portion.

In an embodiment, a clip connected can be to the semi-circular section that extends from the top circular portion.

In an embodiment, the plug portion may include a plurality of plug sections.

In an embodiment, the aforementioned grooves can respectively separate each plug section among the plurality of sections from one another.

In an embodiment, the plurality of plug sections may comprise four plug sections.

In an embodiment, an ignition cover can include: a top circular portion located above and coupled to a plug portion that extends angularly from the top circular portion; and the plug portion having a bottom circular portion with a radius smaller than that of the top circular portion, wherein the plug portion fits within a cavity of an ignition with the top circular portion disposed on the ignition cover and adapted to protect the ignition, wherein the top circular portion has a width that is smaller than that of the plug portion, wherein the ignition cover functions as a plug to protect the ignition.

In an embodiment, a method for protecting an ignition of a vehicle, can involve: inserting a plug portion of an ignition cover into a cavity of the ignition, the plug portion extending angularly from a top circular portion, wherein the plug portion has a bottom circular portion with a radius smaller than that of the top circular portion; positioning the top circular portion of the ignition cover on the ignition such that it covers the ignition and protects it from external elements; utilizing a semi-circular section extending from the top circular portion as a handle to grab and manipulate the ignition cover for placement or removal; and maintaining a seal between the plug portion and the ignition cavity.

The ignition cover discussed herein offers an innovative and practical solution for protecting motorcycle ignitions. Its multifunctional design combines durability, reliability, and aesthetic appeal, providing an effective barrier against environmental elements such as rain, dirt, snow, and UV exposure, which can damage the ignition system. The cover's construction, which may utilize rubber, silicone, TPE, or other durable materials, ensures long-lasting performance, weather resistance, and chemical tolerance, making it suitable for diverse environments and conditions.

Key features such as the low-profile design, semi-circular handle, and optional key ring/clip enhance its usability and convenience. The ergonomic handle allows for easy installation and removal without tools, while the key ring/clip provides a secure storage solution for keys. The grooves between the plug sections allow for flexibility and a snug fit, ensuring optimal protection and ease of use.

The ignition cover's potential for customization with color-matching, logos, or patterns adds a personal touch for riders, maintaining both functionality and visual appeal. Its compatibility with various motorcycles and its cost-effectiveness make it a valuable accessory for riders of all experience levels.

By addressing common challenges faced by motorcyclists and offering versatile, user-friendly features, the ignition cover stands out as a reliable, innovative, and indispensable solution for protecting ignition systems and enhancing the riding experience.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. An ignition cover, comprising:
a top circular portion located above and coupled to a plug portion that extends angularly from the top circular portion, with the plug portion having a bottom circular portion with a radius smaller than that of the top circular portion, wherein the plug portion fits within a cavity of an ignition with the top circular portion disposed on the ignition cover and adapted to protect the ignition, wherein the top circular portion has a width that is smaller than that of the plug portion; and
a semi-circular section that extends from the top circular portion to provide a handle to grab and manipulate the ignition cover, wherein the ignition cover functions as a plug to protect the ignition.

2. The ignition cover of claim 1 wherein the top circular portion, the plug portion, and the semi-circular portion comprise a rubber material.

3. The ignition cover of claim 1 further comprising a key ring/clip connected to the semi-circular section that extends from the top circular portion.

4. The ignition cover of claim 1 further comprising a key ring connected to the semi-circular section that extends from the top circular portion.

5. The ignition cover of claim 1 further comprising a clip connected to the semi-circular section that extends from the top circular portion.

6. The ignition cover of claim 1 wherein the plug portion comprises a plurality of plug sections.

7. The ignition cover of claim 6 wherein grooves respectively separate each plug section among the plurality of sections from one another.

8. The ignition cover of claim 1 wherein the plug portion comprises a plurality of plug sections wherein grooves respectively separate each plug section among the plurality of sections from one another.

9. The ignition cover of claim 8 wherein the plurality of plug sections comprises four plug sections.

10. An ignition cover, comprising:
a top circular portion located above and coupled to a plug portion that extends angularly from the top circular portion; and
the plug portion having a bottom circular portion with a radius smaller than that of the top circular portion, wherein the plug portion fits within a cavity of an ignition with the top circular portion disposed on the ignition cover and adapted to protect the ignition, wherein the top circular portion has a width that is smaller than that of the plug portion, wherein the ignition cover functions as a plug to protect the ignition.

11. The ignition cover of claim 10 further comprising a semi-circular section that extends from the top circular portion to provide a handle to grab and manipulate the ignition cover.

12. The ignition cover of claim 10 wherein the plug portion comprises a plurality of plug sections wherein grooves respectively separate each plug section among the plurality of sections from one another.

13. The ignition cover of claim 12 wherein the plurality of plug sections comprises four plug sections.

14. The ignition cover of claim 11 wherein the plug portion comprises a plurality of plug sections wherein grooves respectively separate each plug section among the plurality of sections from one another.

15. A method for protecting an ignition of a vehicle, comprising:
inserting a plug portion of an ignition cover into a cavity of the ignition, the plug portion extending angularly from a top circular portion, wherein the plug portion has a bottom circular portion with a radius smaller than that of the top circular portion;
positioning the top circular portion of the ignition cover on the ignition such that it covers the ignition and protects it from external elements;
utilizing a semi-circular section extending from the top circular portion as a handle to grab and manipulate the ignition cover for placement or removal; and
maintaining a seal between the plug portion and the ignition cavity.

16. The method of claim 15 wherein the plug portion comprises a plurality of plug sections.

17. The method of claim 16 wherein the plurality of plug sections comprises four plug sections.

18. The method of claim 15 wherein the plug portion comprises a plurality of plug sections wherein grooves respectively separate each plug section among the plurality of sections from one another.

19. The method of claim 18 wherein the plurality of plug sections comprises four plug sections.

20. The method of claim 15 wherein the seal between the plug portion and the ignition cavity prevent the ingress of dust, moisture, or debris.
